(19) United States
(12) Patent Application Publication
(10) Pub. No.: US 2020/0384828 A1
(43) Pub. Date: Dec. 10, 2020

(54) OUTLET FOCUSED WARM AIR CHANNEL

(71) Applicant: Hanon Systems, Daejeon (KR)

(72) Inventors: Jayanthi Iyer, Northville, MI (US); Eric Haupt, Livonia, MI (US); Michael Mungle, Brighton, MI (US); Megan Stabile, New Hudson, MI (US)

(21) Appl. No.: 15/931,687

(22) Filed: May 14, 2020

Related U.S. Application Data
(60) Provisional application No. 62/858,535, filed on Jun. 7, 2019.

(51) Int. Cl. B60H 1/00

(52) U.S. Cl. CPC B60H 1/00564; B60H 1/00664; B60H 1/00842; B60H 2001/00114; B60H 1/00295; B60H 1/00285; B60H 1/00028

(57) ABSTRACT

An air-handling system for a heating, ventilation, and air conditioning system of a passenger vehicle is provided that includes a heated air conduit configured to receive a portion of a heated air flow from a heat exchanger in a conditioning section and directly deliver the portion of the heated air flow to a vent in the passenger vehicle. The portion of the heated air flow is separate from an unconditioned air flow, a conditioned air flow, and a remainder of the heated air flow, each of which run from the conditioning section to a common mixing section forming an output air flow. The delivery section distributes the output air flow to a plurality of conduits leading to a plurality of vents in the passenger vehicle.

### CROSS-REFERENCE TO RELATED APPLICATIONS

This patent application claims the benefit of U.S. Provisional Patent Application No. 62/858,535, filed on Jun. 7, 2019. The entire disclosure of the above application is incorporated herein by reference.

### FIELD

The present technology relates to a climate control system for a vehicle, and more particularly to a climate control system for a heating, ventilating, and air conditioning system having improved warm air discharge at an outlet such as a defrost vent.

### INTRODUCTION

This section provides background information related to the present disclosure that is not necessarily prior art.

A vehicle can include a climate control system to maintain a temperature within a passenger compartment of the vehicle at a comfortable level by providing heating, cooling, and ventilation. Comfort can be maintained in the passenger compartment by an integrated mechanism referred to in the art as a heating, ventilation, and air conditioning (HVAC) air-handling system. The air-handling system conditions air flowing therethrough and distributes the conditioned air throughout the passenger compartment.

The air-handling system can employ a housing having a plurality of passageways and doors for controlling a temperature and a flow of air therethrough. The housing can be divided into an inlet section, a conditioning section, a mixing section, and a delivery section. The inlet section can include a blower or fan for delivering the air to the conditioning section. The conditioning section can include one or more heat exchangers for controlling temperature and humidity of the air. Control features disposed within the conditioning section can control a flow of the air through one or more passageways having the heat exchangers disposed therein. For example, temperature doors, also referred to as flaps or valves, can be employed to control the flow of the air through the one or more passageways. The mixing section can be disposed downstream of the conditioning section and can form a chamber for recombining each of the streams of air, whether heated or cooled, exiting the conditioning section. The delivery section can include one or more conduits or ducts branching from the mixing section for delivering the conditioned air to one or more vents located within the passenger compartment of the vehicle.

Vents disposed within the passenger compartment may include panel vents, console vents, front floor vents, rear floor vents, windshield defrost vents, and side window defrost vents, for example. The delivery section can be configured to deliver the air originating from the mixing section to any combination of the vents based on an operating mode selected by a passenger of the vehicle. Each operating mode can include a preselected percentage (or distribution ratio) of the air originating from the mixing section delivered to each of the corresponding vents associated with the selected operating mode. Doors disposed within the delivery section can be actuated to control the distribution of the air to each of the desired vents by blocking and/or opening various passageways disposed within the delivery section. For example, a “panel operating mode” can include air distributed only to one or more panel vents and console vents, a “defrost operating mode” can include air distributed only to one or more windshield defrost vents and side window defrost vents, and a “floor operating mode” can include air distributed to one or more front floor vents, rear floor vents, windshield defrost vents, and side window defrost vents. As such, air ultimately reaching a respective vent may have received temperature and/or humidity changes in the conditioning section of the system, but has since experienced recombination into the mixing section and passage along or past various portions of the delivery section.

Certain issues associated with the distribution of the air to each of the vents of the delivery section relate to differences in flow rate and pressures of the air required at an outlet of each of the vents to achieve a desired distribution of the air for each of the operating modes. The pathway and speed at which an air flow reaches a particular vent can accordingly affect the conditioning of the air. For example, variable restriction and/or opening of the flow paths by actuating one or more doors disposed within the flow paths can be used to control pressure and flow rate of air through each of the flow paths.

Ways to address issues with the flow of air through the conditioning section, the mixing section, and the delivery section of the HVAC system can therefore include controlling the flow of air in multiple pathways having multiple doors, ultimately directing air flow to a desired vent. For example, windshield defrost vents and side window defrost vents can be supplied from a flow path or channel that involves direction using multiple doors and mixing paths that operate to control access to other vents (e.g., panel vents, floor vents, etc.) before ultimately controlling distribution to one or more defrost vents. However, such configurations can present a circuitous route involving multiple components, including doors, actuators, links, or control elements, for other vent destinations, which can result in temperature and/or humidity changes along the pathway that are not optimal for defrosting operations by the air handling system. What is more, combination of air flows from the condition section within the mixing section can offset desired temperature and/or humidity effects for certain vent locations; e.g., providing warm and/or dry air to a defrost vent.

Accordingly, there exists a need to provide improved distribution of warm and/or dry air to various vents of an air handling system within a passenger vehicle, including windshield defrost vents, side window defrost vents, and panel vents, for example.

### SUMMARY

The present technology includes articles of manufacture, systems, and processes that relate to an air-handling system for a heating, ventilating, and air conditioning system having one or more channels for moving warm air from a heat exchanger directly into one or more defrost vents.

Air-handling systems for a passenger vehicle are provided that include an inlet section, a condition section, a mixing section, a distribution section, and a heated air conduit. The inlet section is configured to provide an air flow. The conditioning section is configured to receive the air flow from the inlet section and provide (i) an unconditioned air flow, (ii) a conditioned air flow that includes changing a member selected from the group consisting of a humidity of the air flow, a temperature of the air flow, and combinations thereof, and (iii) a heated air flow, where the conditioning section includes a heat exchanger configured to provide the heated air flow. The mixing section is operable to receive the unconditioned air flow, the conditioned air flow, and the heated air flow, wherein receipt of more than one of the unconditioned air flow, the conditioned air flow, and the heated air flow results in mixing thereof, the mixing section providing an output air flow. The delivery section is configured to distribute the output air flow to a plurality of conduits leading to a plurality of vents in the passenger vehicle. The heated air conduit is configured to receive a portion of the heated air flow from the heat exchanger in the conditioning section and directly deliver the portion of the heated air flow to a vent in the passenger vehicle. The heated air conduit can be configured to receive the portion of the heated air flow from the heat exchanger in the conditioning section and directly deliver the portion of the heated air flow to a panel vent and/or a defrost vent in the passenger vehicle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic of an air-handing system for a heating, ventilating, and air conditioning (HVAC) system of a passenger vehicle according to an embodiment of the present technology.

FIG. 2 is a schematic of an air-handing system for a heating, ventilating, and air conditioning (HVAC) system of a passenger vehicle according to another embodiment of the present technology.

FIG. 3 is a schematic of a passenger vehicle including an air-handling system according to the present technology, where the air-handling system directs air flows to various portions of the passenger vehicle.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology relates to climate control systems for a vehicle, and more particularly to air handling systems for a heating, ventilating, and air conditioning system that has one or more pathways, channels, or conduits for moving hot air from a heat exchanger directly into one or more vents within a passenger vehicle. Embodiments of such air-handling systems can include an inlet section configured to provide an air flow. A conditioning section can be configured to receive the air flow from the inlet section and provide (i) an unconditioned air flow, (ii) a conditioned air flow that includes changing a member selected from the group consisting of a humidity of the air flow, a temperature of the air flow, and combinations thereof, and (iii) a heated air flow. The conditioning section can include a heat exchanger configured to provide the heated air flow. A mixing section can be operable to receive the unconditioned air flow, the conditioned air flow, and the heated air flow, wherein receipt of more than one of the unconditioned air flow, the conditioned air flow, and the heated air flow results in mixing thereof. The mixing section can provide an output air flow where a delivery section can be configured to distribute the output air flow to a plurality of conduits leading to a plurality of vents in the passenger vehicle. A heated air conduit can be configured to receive a portion of the heated air flow from the heat exchanger in the conditioning section and directly deliver the portion of the heated air flow to a vent in the passenger vehicle. The heated air conduit can be configured to receive the portion of the heated air flow from the heat exchanger in the conditioning section and directly deliver the portion of the heated air flow to a one or more vents in the passenger vehicle, including a panel vent and/or a defrost vent.

In this way, the present technology can provide heated air to one or more certain vents as compared to other climate control systems. The present technology can therefore use the direct provision of heated air to provide certain benefits and advantages. In particular, direct delivery of the portion of the heated air flow from the heat exchanger can provide heated air that is not mixed with unconditioned air and/or conditioned air, where the heated air flow is accordingly undiluted with air flows of differing temperatures and/or humidities. Direct delivery can allow the portion of the heated air flow to better maintain a desired temperature. The heated air conduit delivering the portion of the heated air flow can also be configured with a length and cross-section tailored to deliver a desired heated air flow at a particular vent. For example, it can be easier to maintain a flow rate for heated air moving from a heat exchanger passing through the heated air conduit directly to a vent, as compared to a flow rate for heated air passing through a mixing section, with an increase in volume, presence of one or more baffles, turns or curves, etc. before reaching the same vent location. The heated air conduit can also take a shorter or more direct route to a particular vent location as opposed to an air flow passing through a mixing section prior to distribution by a delivery section of the air-handling system. Flow rate of the portion of heated air moving through the heated air conduit can be maximized and temperature loss can be minimized in such fashion. Rapid, direct, and undiluted heated air can therefore be provided to certain areas of the passenger vehicle. In this way, the present technology provides improved distribution of heated and/or dry air to various vents of an air handling system within a passenger vehicle, including windshield defrost vents, side window defrost vents, and panel vents, for example.

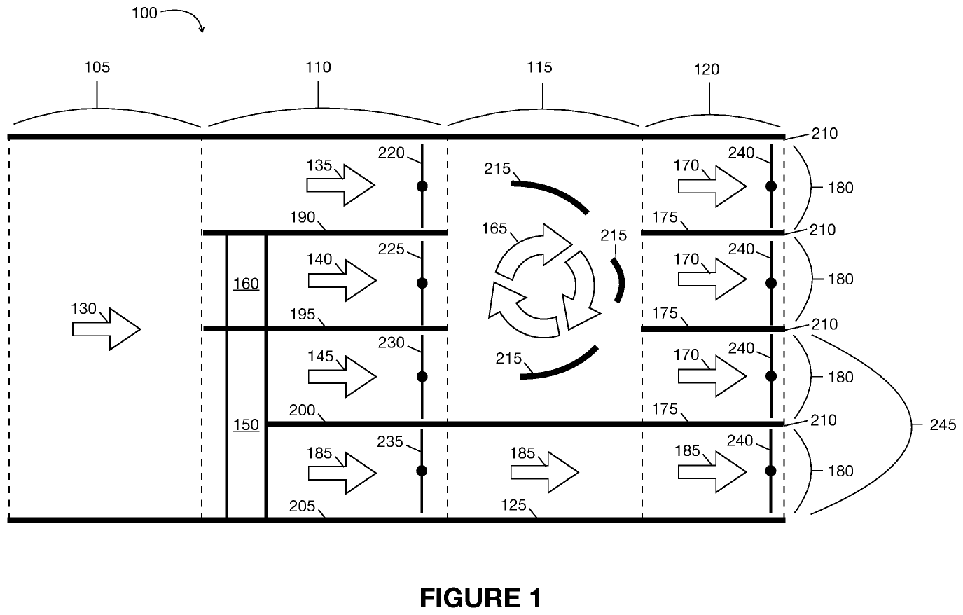

With reference now to FIG. 1, a first first embodiment of an air-handling system for a heating, ventilation, and air conditioning system of a passenger vehicle is generally shown at 100. The air-handling system 100 includes an inlet section 105, a conditioning section 110, a mixing section 115, a delivery section 120, and a heated air conduit 125. Boundaries of the inlet section 105, the conditioning section 110, the mixing section 115, and the delivery section 120 are generally demarcated by the respective stippled lines shown in FIG. 1.

The inlet section 105 is configured to provide an air flow depicted by arrow 130. The air flow 130 can be sourced by ambient air external to the air-handling system 100, which can ultimately be sourced from ambient air external to the passenger vehicle. The air flow 130 can be subjected to one or more filters (not shown) within or prior to the inlet section 105. One or more blowers or fans (not shown) can also be used to provide and/or regulate the air flow 130 within or prior to the inlet section 105. It should be noted that such filters, blowers, and/or fans can be positioned elsewhere within or downstream of the air-handling system 100.

The conditioning section 110 is configured to receive the air flow 130 from the inlet section 105 and provide (i) an unconditioned air flow, as depicted by arrow 135, (ii) a conditioned air flow, as depicted by arrow 140, that includes changing a humidity of the air flow 130 and/or a temperature of the air flow 130, and (iii) a heated air flow, as depicted by arrow 145. The conditioning section 110 includes a heat exchanger 150 configured to provide the heated air flow 145. In FIG. 1, the heat exchanger 150 is positioned so that the air flow 130 from the inlet section 105 passes through the heat exchanger 150, where it is warmed, to provide the heated air flow 145. For example, the heat exchanger 150 can be formed of a series of channels of heat exchange fluid and fins (not shown) where the air flow 130 passes across and/or between the channels and fins; e.g., a liquid-air convective radiator. It is also possible to have the air flow 130 pass over or across the heat exchanger 150, instead of through the heat exchanger 150 structure.

The conditioning section 110 can also include an evaporator 160 to provide the conditioned air flow 140. One example of the evaporator 160 includes a radiator coil in closed compressor driven circulation of a working fluid. The evaporator 160 can thereby change the humidity and/or temperature of the air flow 130 from the inlet 105 to provide the conditioned air flow 140. For example, the evaporator 160 can form a portion of a primary refrigerant circuit of an air conditioning system (not shown) associated with the air-handling system 100. The evaporator 160 can be configured to exchange heat energy between the air flow 130 from the inlet 105 and a working fluid flowing through the evaporator 160 to cool and/or dehumidify the air flow 130 into the conditioned air flow 140. Although described as an evaporator 160, it should be understood other types and forms of cooling devices in a heat exchange relationship with other components or portions of the air-handling system 100 and/or the passenger vehicle can be employed for use with the air-handling system 100 in place of or in addition to the evaporator 160. It is also possible to have the air flow 130 pass over or across the evaporator 160, instead of through the evaporator 160 structure, as depicted.

The mixing section 115 is operable to receive the unconditioned air flow 135, the conditioned air flow 140, and the heated air flow 145, wherein receipt of more than one of the unconditioned air flow 135, the conditioned air flow 140, and the heated air 145 flow results in mixing thereof, as depicted by arrows 165. The mixing section accordingly can provide one or more output air flows, as depicted by arrows 170, which are received by the delivery section 120. The mixing section 115 can be configured having various sizes, shapes, volumes, etc., other than as shown.

The delivery section 120 is configured to distribute the output air flow 170 to one ore more conduits 175 leading to one or more vents 180 in the passenger vehicle. In the embodiment depicted in the figures, the delivery section 120 includes three conduits 175, each leading to a vent 180. However, it should be noted that any given conduit 175 can have more than one vent 180 outlet as well as branch to more than one vent 180. Each conduit 175 can also have a different length and/or size depending upon the ultimate vent 180 type and location within the passenger vehicle.

The heated air conduit 125 is configured to receive a portion of the heated air flow from the heat exchanger 150, as depicted by arrows 185, in the conditioning section 110 and directly deliver the portion 185 of the heated air flow to a vent 180 in the passenger vehicle. That is, the heated air conduit 125 can be configured as a dedicated means to provide the portion 185 of heated air flow to one or more particular vents 180. In this way, the portion 185 of heated air flow can maintain an original humidity and minimize a temperature loss therefrom. The portion 185 of the heated air flow is shown originating from the same heat exchanger 150 used to provide the heated air flow 145. However, it is possible that a duplicate, different, or dedicated heat exchanger other than heat exchanger 150 can be used to provide the portion 185 of heated air flow.

It should be noted that dimensions of the various features of the air-handling system 100 as shown in the figures are representative and provided solely for illustrative purposes, where one skilled in the art appreciates that various sizes, lengths, volumes, cross-sections, arrangements, directions, positions, and shapes of the respective features other than those shown can be employed. That is, the inlet section 105, the conditioning section 110, the mixing section 115, the delivery section 120, the heated air conduit 125, and features and subcomponents of each can vary in their respective physical parameters. It should also be appreciated that the number, configuration, and lengths of the various conduits 175 leading to the various vents 180 can be dependent on a particular passenger vehicle configuration, including make, model, trim level, etc.

Air flows within the air-handling system 100 can take various pathways therethrough. For example, the air flow 130 through the inlet section 105, the unconditioned air flow 135, the conditioned air flow 140, and the heated air flow 145 through the conditioning section, the mixed air flow 165 in the mixing section 115, and the output air flow(s) 170 in the delivery section 120 can each take certain pathways through the air-handling system 100, including pathways having discrete and/or common portions. As shown in the figures, the conditioning section 110 can include a first pathway 190 connecting the inlet section 105 and the mixing section 115 to provide the unconditioned air flow 135. The conditioning section 110 can include a second pathway 195 including the evaporator 160, where the second pathway 195 connects the inlet section 105 and the mixing section 115 to provide the conditioned air flow 140. The conditioning section 110 can include a third pathway 200 including the heat exchanger 150, where the third pathway 200 connects the inlet section 105 and the mixing section 115 to provide the heated air flow 145. The conditioning section 110 can include a fourth pathway 205 including the heat exchanger 150, where the fourth pathway 205 receives the portion 185 of the heated air flow from the heat exchanger 150 in the conditioning section 110 and directly delivering the portion 185 of the heated air flow through the heated air conduit 125 to the vent 180 in the passenger vehicle.

As shown in the figures, the fourth pathway 205 can be a part of the heated air conduit 125 within the conditioning section 110, where a remainder of the heated air conduit traverses, but is not in fluid communication with, the mixing section 115 and proceeds past the delivery section 120. It should be noted, however, that the heated air conduit 125 can take another pathway following the fourth pathway 205, where the heated air conduit does not have to pass alongside, adjacent, or through the regions of the air-handling system 100 designated as the mixing section 115 and delivery section 120. The fourth pathway 205, and the remainder of the heated air conduit 125, can accordingly provide a bypass of the mixing section 115, unlike the heated air flow 145 that can be received, along with the unconditioned air flow 135 and/or the conditioned air flow 140, in the mixing section 115, where the unconditioned air flow 135, the conditioned air flow 140, and/or the heated air 145 flow can be mixed, as depicted by arrows 165.

With respect to FIG. 1, the heated air conduit 125 is configured to receive the portion 185 of the heated air flow from the heat exchanger 150 in the conditioning section 110 and directly deliver the portion 185 of the heated air flow to at least one vent 180 of the plurality of vents 180. The various vents 180 can be positioned within the passenger vehicle at various locations, included where the various vents 180 are generally referred to as a defrost vent, a panel vent, a floor vent, a side window vent, a seating vent, and/or a vent located beyond a first seating row in the passenger vehicle depending on location and function thereof. In certain embodiments, the heated air conduit 125 is configured to receive the portion 185 of the heated air flow from the heat exchanger 150 in the conditioning section 110 and directly deliver the portion 185 of the heated air flow to an outlet 210 of at least one vent of the plurality of vents 180. In certain embodiments, the heated air conduit 125 is configured to receive the portion 185 of the heated air flow from the heat exchanger 150 in the conditioning section 110 and directly deliver the portion 185 of the heated air flow to a panel vent 180 or to an outlet 210 of the panel vent 180 in the passenger vehicle. In certain embodiments, the heated air conduit 125 is configured to receive the portion 185 of the heated air flow from the heat exchanger 150 in the conditioning section 110 and directly deliver the portion 185 of the heated air flow to a defrost vent 180 or to an outlet 210 of the defrost vent 180 in the passenger vehicle.

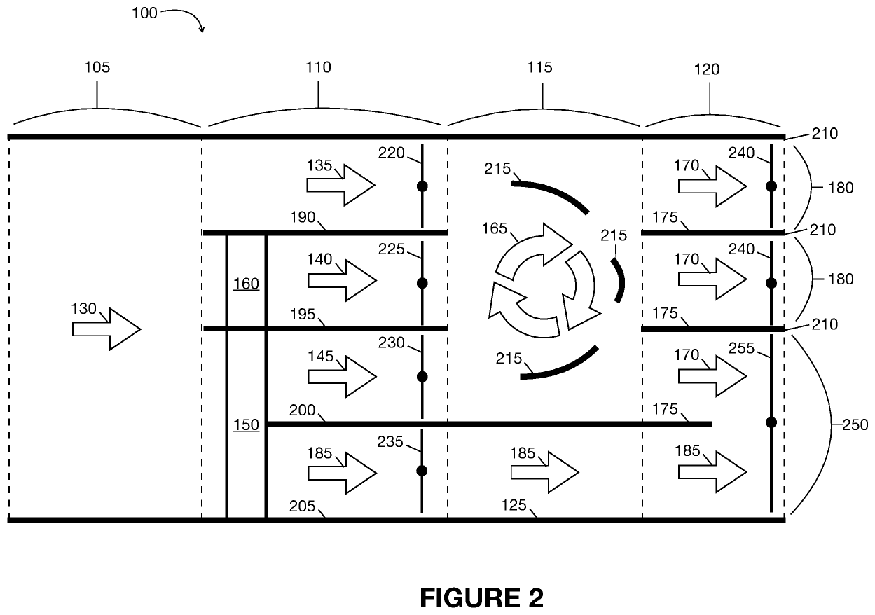

As shown in both FIGS. 1-2, the mixing section 115 can include one or more baffles 215. The embodiments depicted include three such baffles 215, which can take various shapes, forms, lengths, sizes, etc. The one or more baffles 215 are designed to facilitate mixing of the unconditioned air flow 135, the conditioned air flow 140, and/or the heated air flow 145, as depicted by arrows 165. Baffles 215 can be designed to induce turbulence in air flows and/or to direct different air flows into or across each other.

Air flows within the air-handling system 100 can be controlled in various ways. Various doors can regulate air flows, including allowing a maximum value of a respective air flow to a minimum value of the respective air flow, where the minimum value can be substantially no air flow. In particular, a first door 220 can control the unconditioned air flow 135, a second door 225 can control the conditioned air flow 140, and/or a third door 230 can control the heated air flow 145. The heated air conduit 125 can include a fourth door 235 to control delivery of the portion 185 of the heated air flow to the respective vent 180 in the passenger vehicle.

The first, second, third, and fourth pathways 190, 195, 200, 205 taken by the respective air flows 135, 140, 145, 185 can be configured as channels or conduits of various lengths, as depicted in FIGS. 1-2. However, one skilled in the art recognizes that the first, second, third, and fourth pathways 190, 195, 200, 205 can have little to no conduit-like length and can be configured and/or controlled by doors positioned in certain locations and positions. The first, second, third doors 220, 225, 230 can control the respective air flows 135, 140, 145 without the first, second, and third pathways 190, 195, 200 being part of conduits. Only the fourth pathway 205 continues to the heated air conduit 125, whereas the first, second, and third pathways 190, 195, 200 can be defined by the respective doors 220, 225, 230 positioned relative to the heat exchanger 150, evaporator 160, or neither, that provide first, second, and third pathways 190, 195, 200 to the mixing section 115.

It is noted that the various output air flows 170 delivered to the various vents 180, as well as the portion 185 of the heated air flow running to the respective vent 180, can each also be controlled by one or more doors 240. Examples of doors 240 include louvers, flaps, slides, etc. that can control an amount of air flow as well as a direction of the air flow at the outlets 210 of the vents 180. In general, certain vent 180 outlets 210 have doors 240 that can be controlled by an occupant of the passenger vehicle in order to reduce the amount of air flowing therethrough and/or to direct the air flow to certain locations.

As shown in FIG. 1, the heated air conduit 125 can be configured to receive the portion 185 of the heated air flow from the heat exchanger 150 in the conditioning section 110 and directly deliver the portion 185 of the heated air flow to at least one vent 180 of the plurality of vents 180, where the at least one vent 180 is adjacent another vent 180, to provide dual vent outlets 245. The dual vent outlets 245 can be located at a particular location in the passenger vehicle, where the dual vent outlets 245 operate together as a defrost vent or a panel vent, for example. The dual vent outlets 245 can still be independently controlled by their respective doors 240 or can share a common door; e.g., see FIG. 2.

With reference now to FIG. 2, the portion 185 of the heated air flow from the heated air conduit 125 can be fluidly coupled to at least one of the conduits 175 leading to one or more of the plurality of vents 180 in the passenger vehicle. In this way, the portion 185 of the heated air flow is joined and/or combined with one of the output air flows 170 to exit a common vent 250. Rate of air flow and/or direction through the common vent 250 can be controlled by a common vent door 255. The portion 185 of the heated air flow from the heated air conduit 125 can be joined and/or combined with the output air flow 170 at various positions along the conduit 175 and the heated air conduit 125. In certain embodiments, the portion 185 of the heated air flow from the heated air conduit 125 can be fluidly coupled to the conduit 175 leading to the common vent 250 at or near the vent outlet 210. In this way, mixing between the portion 185 of the heated air flow and any output air flow 170 is minimized prior to discharge at the outlet 210.

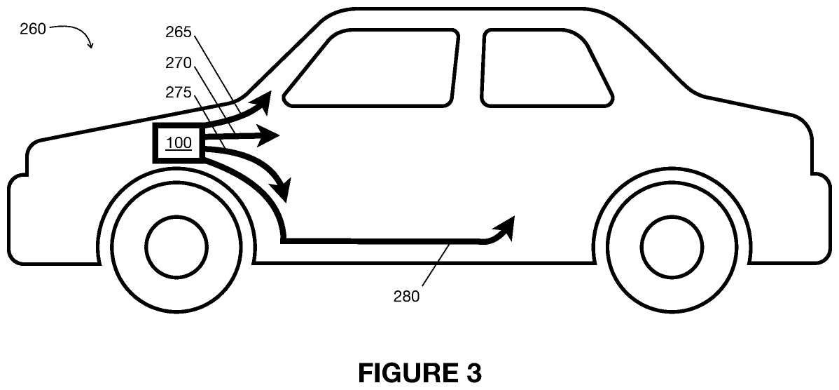

With reference now to FIG. 3, a passenger vehicle 260 including an air-handling system 100 is shown. Various conduits running to various vent outlets are depicted, including a conduit running to a defrost vent 265, a conduit running to a panel vent 270, a conduit running to a floor vent 275, and a conduit running to a vent 280 located beyond a first seating row in the passenger vehicle 260. Each of these conduits running to respective vents 265, 270, 275, 280 can be configured as: (1) the heated air conduit 125 that receives a portion of the heated air flow from the heat exchanger 150 in the conditioning section 110 and directly delivers the portion 185 of the heated air flow to a vent 180 in the passenger vehicle 260; (2) the heated air conduit 125 that receives a portion of the heated air flow from the heat exchanger 150 in the conditioning section 110 and directly delivers the portion 185 of the heated air flow to a vent 180 that is adjacent another vent 180, to provide dual vent outlets 245 in the passenger vehicle 260; (3) the portion 185 of the heated air flow is joined and/or combined with one of the output air flows 170 to exit a common vent 250 location in the passenger vehicle 260.

Also provided herein are ways of operating an air-handling system for a heating, ventilation, and air conditioning system of a passenger vehicle. These include the provision of an unconditioned air flow, a conditioned air flow, a heated air flow, and mixtures thereof at one or more vents within a passenger vehicle while also providing a heated air flow directly to one or or more of the same or different vents. Certain embodiments include a method of operating an air-handling system for a heating, ventilation, and air conditioning system of a passenger vehicle, where the method comprises providing an air-handling system according to the present technology and receiving, in the heated air conduit, a portion of the heated air flow from the heat exchanger in the conditioning section and directly delivering the portion of the heated air flow to the vent in the passenger vehicle. In this way, rapid, direct, and undiluted heated air can therefore be provided to one or more locations in the passenger vehicle, including windshield defrost vents, side window defrost vents, and panel vents, for example.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. An air-handling system for a heating, ventilation, and air conditioning system of a passenger vehicle comprising:
an inlet section configured to provide an air flow;
a conditioning section configured to receive the air flow from the inlet section and provide (i) an unconditioned air flow, (ii) a conditioned air flow that includes changing a member selected from the group consisting of a humidity of the air flow, a temperature of the air flow, and combinations thereof, and (iii) a heated air flow, where the conditioning section includes a heat exchanger configured to provide the heated air flow;
a mixing section operable to receive the unconditioned air flow, the conditioned air flow, and the heated air flow, wherein receipt of more than one of the unconditioned air flow, the conditioned air flow, and the heated air flow results in mixing thereof, the mixing section providing an output air flow;
a delivery section configured to distribute the output air flow to a plurality of conduits leading to a plurality of vents in the passenger vehicle; and
a heated air conduit configured to receive a portion of the heated air flow from the heat exchanger in the conditioning section and directly deliver the portion of the heated air flow to a vent in the passenger vehicle.

2. The air-handling system according to claim 1, wherein the conditioning section includes a first pathway connecting the inlet section and the mixing section to provide the unconditioned air flow.

3. The air-handling system according to claim 1, wherein the conditioning section includes a second pathway including an evaporator, the second pathway connecting the inlet section and the mixing section to provide the conditioned air flow.

4. The air-handling system according to claim 1, wherein the conditioning section includes a third pathway including a heat exchanger, the third pathway connecting the inlet section and the mixing section to provide the heated air flow.

5. The air-handling system according to claim 1, wherein the conditioning section includes a fourth pathway including a heat exchanger, the fourth pathway receiving the portion of the heated air flow from the heat exchanger in the conditioning section and directly delivering the portion of the heated air flow through the heated air conduit to the vent in the passenger vehicle

6. The air-handling system according to claim 5, wherein the fourth pathway provides a bypass of the mixing section.

7. The air-handling system according to claim 1, wherein the portion of the heated air flow from the heated air conduit is fluidly coupled to at least one of the conduits leading to the plurality of vents in the passenger vehicle.

8. The air-handling system according to claim 7, wherein the portion of the heated air flow from the heated air conduit is fluidly coupled to at least one of the conduits leading to the plurality of vents in the passenger vehicle at a vent outlet.

9. The air-handling system according to claim 1, wherein the heated air conduit is configured to receive the portion of the heated air flow from the heat exchanger in the conditioning section and directly deliver the portion of the heated air flow to at least one vent of the plurality of vents.

10. The air-handling system according to claim 9, wherein the heated air conduit is configured to receive the portion of the heated air flow from the heat exchanger in the conditioning section and directly deliver the portion of the heated air flow to an outlet of at least one vent of the plurality of vents.

11. The air-handling system according to claim 1, wherein the heated air conduit is configured to receive the portion of the heated air flow from the heat exchanger in the conditioning section and directly deliver the portion of the heated air flow to a panel vent in the passenger vehicle.

12. The air-handling system according to claim 11, wherein the heated air conduit is configured to receive the portion of the heated air flow from the heat exchanger in the conditioning section and directly deliver the portion of the heated air flow to an outlet of the panel vent in the passenger vehicle.

13. The air-handling system according to claim 1, wherein the heated air conduit is configured to receive the portion of the heated air flow from the heat exchanger in the conditioning section and directly deliver the portion of the heated air flow to a defrost vent in the passenger vehicle.

14. The air-handling system according to claim 13, wherein the heated air conduit is configured to receive the portion of the heated air flow from the heat exchanger in the conditioning section and directly deliver the portion of the heated air flow to an outlet of the defrost vent in the passenger vehicle.

15. The air-handling system according to claim 1, wherein the mixing section includes at least one baffle.

16. The air-handling system according to claim 1, further comprising a member selected from a group consisting of: a first door to control the unconditioned air flow; a second door to control the conditioned air flow; a third door to control the heated air flow; and combinations thereof.

17. The air-handling system according to claim 1, wherein the heated air conduit includes a door to control delivery of the portion of the heated air flow to the vent in the passenger vehicle.

18. The air-handling system according to claim 1, wherein the plurality of vents in the passenger vehicle includes a member selected from a group consisting of: a defrost vent; a panel vent; a floor vent; a side window vent; a seating vent; a vent located beyond a first seating row in the passenger vehicle; and combinations thereof.

19. A passenger vehicle comprising an air-handling system according to claim 1.

20. A method of operating an air-handling system for a heating, ventilation, and air conditioning system of a passenger vehicle, the method comprising:
providing an air-handling system according to claim 1; and
receiving, in the heated air conduit, a portion of the heated air flow from the heat exchanger in the conditioning section and directly delivering the portion of the heated air flow to the vent in the passenger vehicle.
